(19) United States
(12) Patent Application Publication
(10) Pub. No.: US 2022/0408947 A1
(43) Pub. Date: Dec. 29, 2022

(54) BLUETOOTH MUSIC FACE PILLOW

(71) Applicant: Jiangsu Mingteng Health Products Co., Ltd, Yancheng (CN)

(72) Inventors: Chuankui Du, Shanghai (CN); Saihua Chen, Shanghai (CN); Jinnian Dong, Shanghai (CN)

(73) Assignee: Jiangsu Mingteng Health Products Co., Ltd, Yancheng, JS (CN)

(21) Appl. No.: 17/900,893

(22) Filed: Sep. 1, 2022

(30) Foreign Application Priority Data
Jul. 23, 2022 (CN) 202221914814.2

(51) Int. Cl. A47G 9/10; H04R 5/02

(52) U.S. Cl. CPC A47G 9/1054; H04R 5/023

(57) ABSTRACT

The present disclosure is applicable to the technical field of massage apparatuses, and provides a Bluetooth music face pillow. The Bluetooth music face pillow includes face pillow sponge, a speaker, an audio wire, a Bluetooth battery compartment, a circuit board, a rechargeable battery and an audio terminal; at least two speakers are configured inside the face pillow sponge; when the user plays an audio file with the mobile phone, the circuit board acquires an audio signal of the mobile phone of the user through Bluetooth and amplifies the audio signal of the mobile phone; the amplified audio electric signal is supplied to the speakers through the audio terminal and the audio wire; and the audio is played back through the audio speakers.

### TECHNICAL FIELD

The present disclosure belongs to the technical field of massage apparatuses, and particularly relates to a Bluetooth music face pillow.

### BACKGROUND

Household or commercial massage couches are often equipped with a sponge face pillow to support the head of a customer. The customer is usually massaged in prone and supine positions for about one hour. During the massage, a technician usually hopes that the customer is immersed in a relaxed state to help the customer experience a comfortable massage experience. In order to help customers relax better, a technician often needs to play soft background music with an indoor speaker to help the customers get relaxed. When there are many customers in one room, a customer who has fallen asleep is often awakened by music. Each customer has a different demand for the track, style and volume of a piece of music, and the volume experienced by the customers in different distances from the indoor speaker will also be different. It is difficult to make all the customers satisfied. Therefore, a Bluetooth music face pillow of the present disclosure is researched and developed.

Some of the existing music face pillows on the market often need to be plugged into a professional music player or are required to be provided with additional batteries or power supply systems, so they are not convenient to use.

### SUMMARY

An embodiment of the present disclosure aims to provide a Bluetooth music face pillow, and aims at solving the problems that an ordinary face pillow cannot provide music and that existing music face pillows are required to be provided with additional power supply systems and additional music players.

The embodiment of the present disclosure is achieved below: A Bluetooth music face pillow includes:

face pillow sponge, a speaker, an audio wire, a Bluetooth battery compartment, a circuit board, a rechargeable battery and an audio terminal. At least two speakers are configured inside the face pillow sponge; the speakers are connected to the audio wire; a tail end of the audio wire is connected to the audio terminal; the circuit board and the rechargeable battery are arranged in the Bluetooth battery compartment; the circuit board is connected to the rechargeable battery; the circuit board is provided with an audio jack; the speakers are electrically connected to the circuit board in a manner of plugging the audio terminal into the audio jack; and the circuit board is connected to a mobile phone of a user through Bluetooth.

In a further technical solution, the Bluetooth battery compartment is connected to the audio terminal at the tail end of the audio wire in a plugging manner.

In a further technical solution, the rechargeable battery arranged in the Bluetooth battery compartment is a battery capable of being recharged.

In a further technical solution, the Bluetooth battery compartment is separated from the music face pillow in a manner of being separated from the audio terminal.

In a further technical solution, a sunken outline used for carrying the face or the back of the head is arranged on the face pillow sponge; and the sunken outline sinks from a center area of the face pillow sponge towards the inside.

In a further technical solution, a hole for the user to breathe in a prone position is formed in the center area of the face pillow sponge.

In a further technical solution, a face pillow cover wraps outside the face pillow sponge; and a pocket for placing the Bluetooth battery compartment is arranged outside the face pillow cover.

In a further technical solution, the Bluetooth battery compartment is connected to a mobile phone of a user through Bluetooth; and the Bluetooth battery compartment acquires an audio signal of the mobile phone of the user through Bluetooth transmission.

According to the Bluetooth music face pillow provided by the embodiment of the present disclosure, a user lies prone or supine on a massage couch, with the head on the music face pillow. A technician initiates Bluetooth of the mobile phone to achieve Bluetooth connection to the Bluetooth battery compartment, and clicks audio playback software in the mobile phone. An audio signal is transmitted to the Bluetooth battery compartment through the Bluetooth. The rechargeable battery in the Bluetooth battery compartment provides electric energy to the circuit board and amplifies the audio signal. The audio signal is transmitted to the speakers through the audio wire. Music is played through the speakers. The user enjoys the massage while listening to the music, and other people in the room will not be disturbed.

### BRIEF DESCRIPTION OF THE DRAWINGS

FIG. 1 is a schematic diagram of a Bluetooth music face pillow provided in an embodiment of the present disclosure;

FIG. 2 is a schematic diagram of a finished product of a Bluetooth music face pillow provided in an embodiment of the present disclosure;

FIG. 3 is an exploded diagram 1 of a Bluetooth music face pillow provided in an embodiment of the present disclosure;

FIG. 4 is an exploded diagram 2 of a Bluetooth music face pillow provided in an embodiment of the present disclosure.

In the drawings: face pillow sponge 1, face pillow cover 2, speaker 3, audio wire 4, Bluetooth battery compartment 5, circuit board 6, rechargeable battery 7, and an audio terminal 8.

### DETAILED DESCRIPTION OF THE EMBODIMENTS

In order to make the objectives, technical solutions and advantages of the present disclosure clearer, the present disclosure is further described in detail below with reference to accompanying drawings and embodiments. It should be understood that the specific embodiments described here are merely to illustrate and explain the present disclosure, and not intended to limit the present disclosure.

Specific implementation of the present disclosure is described in detail below in combination with specific embodiments.

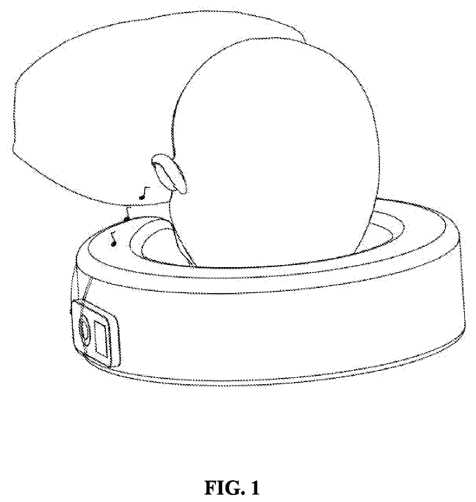

As shown in FIG. 1 to FIG. 4, a Bluetooth music face pillow provided in one embodiment of the present disclosure is illustrated, including:

face pillow sponge 1, a speaker 3, an audio wire 4, a Bluetooth battery compartment 5, a circuit board 6, a rechargeable battery 7 and an audio terminal 8. At least two speakers 3 are configured inside the face pillow sponge 1; the speakers 3 are connected to the audio wire 4; a tail end of the audio wire 4 is connected to the audio terminal 8; the circuit board 6 and the rechargeable battery 7 are arranged in the Bluetooth battery compartment 5; the circuit board 6 is connected to the rechargeable battery 7; the circuit board 6 is provided with an audio jack; the speakers 3 are electrically connected to the circuit board 6 in a manner of plugging the audio terminal 8 into the audio jack; and the circuit board 6 is connected to a mobile phone of a user through Bluetooth.

In the embodiment of the present disclosure, an interlayer is arranged inside the face pillow sponge 1; a left pit and a right pit are arranged in the interlayer; one speaker 3 is placed in each pit; the audio wire 4 is arranged in the interlayer inside the face pillow sponge 1; the audio terminal 8 is in plugging connection to the audio jack on the circuit board 6; and the speakers 3 are electrically connected to the circuit board 6 in a manner of plugging the audio terminal 8 into the audio jack. During use, the circuit board 6 is connected to the mobile phone of the user through Bluetooth, so that when the user plays an audio file with the mobile phone, the circuit board 6 acquires an audio signal of the mobile phone of the user through Bluetooth and amplifies the audio signal of the mobile phone; the amplified audio electric signal is supplied to the speakers 3 through the audio terminal 8 and the audio wire 4; and the audio is played through the audio speakers 3.

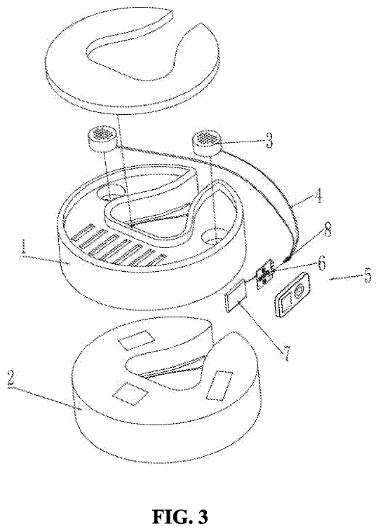

As shown in FIG. 3, as one preferable embodiment of the present disclosure, the Bluetooth battery compartment 5 is connected to the audio terminal 8 at the tail end of the audio wire 4 in a plugging manner.

In the embodiment of the present disclosure, the Bluetooth battery compartment 5 is connected to the audio terminal 8 in the plugging manner, which is convenient for removal and mounting.

As shown in FIG. 3, as one preferable embodiment of the present disclosure, the rechargeable battery 7 arranged in the Bluetooth battery compartment 5 is a battery capable of being recharged.

In the embodiment of the present disclosure, the circuit board 6 is provided with a charging port connected to an external charger to charge the rechargeable battery 7. The rechargeable battery 7 supplies electric energy to the circuit board 6; the audio signal is amplified through the circuit board 6, and an audio electric signal is provided for the speakers 3.

As shown in FIG. 1, as one preferable embodiment of the present disclosure, the Bluetooth battery compartment 5 is separated from the music face pillow in a manner of being separated from the audio terminal 8.

In the embodiment of the present disclosure, the Bluetooth battery compartment 5 is separated from the music face pillow by pulling the audio terminal 8 out of the Bluetooth battery compartment 5.

As shown in FIG. 3, as one preferable embodiment of the present disclosure, the face pillow sponge 1 is of a honeycomb structure.

In the embodiment of the present disclosure, audio vibration can be conducted through air inside the honeycomb structure, and the user can hear the audio when lying supine or prone on the music face pillow.

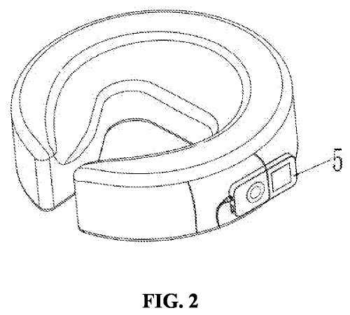

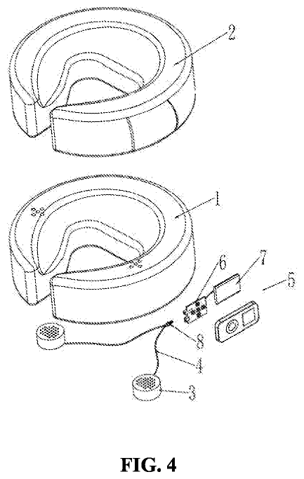

As shown in FIG. 2 and FIG. 4, as one preferable embodiment of the present disclosure, a sunken outline used for carrying the face or the back of the head is arranged on the face pillow sponge 1; and the sunken outline sinks from a center area of the face pillow sponge 1 towards the inside; and a hole for the user to breathe in a prone position is formed in the center area of the face pillow sponge 1.

In the embodiment of the present disclosure, the sunken outline from the center area of the face pillow sponge 1 towards the inside is used for carrying the face when the user lies supine and carrying the back of the head when the user lies prone. There is a hole for the user to breathe in the prone position is formed in the center area of the face pillow sponge 1.

As shown in FIG. 1, as one preferable embodiment of the present disclosure, a face pillow cover 2 wraps outside the face pillow sponge 1; and a pocket for placing the Bluetooth battery compartment 5 is arranged outside the face pillow cover 2.

As shown in FIG. 3 and FIG. 4, as one preferable embodiment of the present disclosure, the Bluetooth battery compartment 5 is connected to a mobile phone of a user through Bluetooth; and the Bluetooth battery compartment 5 acquires an audio signal of the mobile phone of the user through Bluetooth transmission.

According to the Bluetooth music face pillow provided in the above embodiment of the present disclosure, a customer puts the head on the face pillow sponge 1 while enjoying the massage; a massage or beauty technician establishes Bluetooth connection to the circuit board 6 through the Bluetooth of the mobile phone. The technician clicks audio playback software in the mobile phone, selects music to be played through the audio playback software in the mobile phone, enables a music play function of the mobile phone, and adjusts the volume of the music through the playback software in the mobile phone. The customer can hear beautiful music, is immersed in the relaxed atmosphere, get more relaxed, and enjoy the massage service of the technician to the fullest.

The above descriptions are only the preferred embodiments of the present utility model, and are not intended to limit the present utility model. Any modifications, equivalent replacements and improvements that are made within the spirit and principle of the present utility model shall fall within the protection scope of the present utility model.

What is claimed is:

1. A Bluetooth music face pillow, comprising:
face pillow sponge, a speaker, an audio wire, a Bluetooth battery compartment, a circuit board, a rechargeable battery and an audio terminal, wherein at least two speakers are configured inside the face pillow sponge; the speakers are connected to the audio wire; a tail end of the audio wire is connected to the audio terminal; the circuit board and the rechargeable battery are arranged in the Bluetooth battery compartment; the circuit board is connected to the rechargeable battery; the circuit board is provided with an audio jack; the speakers are electrically connected to the circuit board in a manner of plugging the audio terminal into the audio jack; and the circuit board is connected to a mobile phone of a user through Bluetooth.

2. The Bluetooth music face pillow according to claim 1, wherein the Bluetooth battery compartment is connected to the audio terminal at the tail end of the audio wire in a plugging manner.

3. The Bluetooth music face pillow according to claim 1, wherein the rechargeable battery arranged in the Bluetooth battery compartment is a battery capable of being recharged.

4. The Bluetooth music face pillow according to claim 1, wherein the Bluetooth battery compartment is separated from the music face pillow in a manner of being separated from the audio terminal.

5. The Bluetooth music face pillow according to claim 1, wherein a sunken outline used for carrying the face or the back of the head is arranged on the face pillow sponge; and the sunken outline sinks from a center area of the face pillow sponge towards the inside.

6. The Bluetooth music face pillow according to claim 1, wherein a hole for the user to breathe in a prone position is formed in the center area of the face pillow sponge.

7. The Bluetooth music face pillow according to claim 1, wherein a face pillow cover wraps outside the face pillow sponge; and a pocket for placing the Bluetooth battery compartment is arranged outside the face pillow cover.

8. The Bluetooth music face pillow according to claim 1, wherein the Bluetooth battery compartment is connected to a mobile phone of a user through Bluetooth; and the Bluetooth battery compartment acquires an audio signal of the mobile phone of the user through Bluetooth transmission.
